(19) United States
(12) Patent Application Publication
(10) Pub. No.: US 2026/0085670 A1
(43) Pub. Date: Mar. 26, 2026

(54) ELECTROMAGNETIC PROPULSION SYSTEM

(71) Applicant: AEROMAGNETIX LTD., Modiin-Macabim-Reut (IL)

(72) Inventor: Tsachi Itschak COHEN, Modiin-Macabim-Reut (IL)

(21) Appl. No.: 19/121,848

(22) PCT Filed: Nov. 1, 2023
(86) PCT No.: PCT/IL2023/051126

§ 371 Date: Apr. 17, 2025

Related U.S. Application Data
(60) Provisional application No. 63/421,267, filed on Nov. 1, 2022.

(51) Int. Cl. F03H 1/00

(52) U.S. Cl. CPC F03H 1/0056

(57) ABSTRACT

The present subject matter provides an electromagnetic propulsion system comprising: at least one electromagnetic thrustor configured to intake air, ionize the air to produce ionized air, pass the ionized air through at least one electromagnetic field and emit the ionized air in a first direction, to reach acceleration, thereby creating a thrust force in a second direction that is opposite to the first direction, and an electrostatic repulser surrounding the at least one electromagnetic field, configured to pass at least one inducing element therethrough and control a velocity and acceleration rate of the at least one inducing element, wherein a velocity and acceleration rate of the ionized air through the at least one electromagnetic thrustor is induced by the velocity and acceleration rate of the at least one inducing element in the electrostatic repulser. Additional embodiments of the electromagnetic propulsion system are disclosed herein.

### CROSS-REFERENCE TO RELATED APPLICATION

This application claims priority to United States Provisional Ser. No. 63/421,267, filed Nov. 1, 2022, the entire contents of which is incorporated herein by reference in its entirety.

### FIELD

The present subject matter relates to propulsion systems. More particularly, the present subject matter relates to electromagnetic propulsion systems.

### BACKGROUND

Propulsion systems, like jet engines are used for providing a driving force for fast-moving vehicles, for example aircrafts. In general, a jet engine comprises a rotating air compressor powered by a turbine that is configured to compress air into the jet engine. The compressed air is then spayed with liquid fuel and an electric spark lights the mixture of compressed air and sprayed liquid fuel. As a result burning gases are formed, expand and blast out through a nozzle at a back of the jet engine. As the jet of gases shoot backward, the engine jet and the vehicle comprising the engine jet are thrust forward.

Even though the currently known jet engines are capable of thrusting the vehicles, especially aircrafts, at very high speeds, and are widely used, they still have some disadvantages that limit their use. A major disadvantage is the necessity to carry large amounts of liquid fuel by the vehicle, which greatly increases the weight of the vehicle, which in its turn can limit the speed the vehicle can achieve. If there would be no need to carry large amounts of liquid fuel, the vehicle could have reached much higher speeds, especially when the vehicle is an aircraft. Also the size of the vehicle could have been reduced if there was no need to carry liquid fuel by the vehicle.

Another disadvantage of the current jet engines is air pollution due to combustion of fossil fuel, like petrol-based aviation fuel, gasoline and the like.

Another emerging field in the art of aviation is electric Vertical Take Off & Landing (eVTOL). This fast growing industry of air vehicles is based on a decade of technological evolution of unmanned aerial vehicles (UAVs), also known as drones, that use vertical lift electrical propulsion systems. This technology utilizes at least one vertical propeller, or rotor, which rotates by an electric motor at a very high velocity. During its operation, the at least one propeller, or rotor, sucks air from above the propeller, or rotor, and creates a downwash thrust under the propeller, or rotor. The number of propellers, or rotors, can differ among eVTOLs and be, for example, 3, 4, 6, 8, 12, 15, or even 36.

In recent years the technology has been improved, for example by increasing the thrust/weight ratio of the air vehicle. However, still the current air vehicle drones and many brands of e VTOL are capable of hovering and flying for a limited time of up to two hours only. This is due some basic limitations that lie upon energy consumption, which mostly relies on electric power source (battery) density. Basically, the limitation of these propulsion systems can relate to three main parameters: battery density, efficiency of the electric motors and the total weight of the drone, or eVTOL. Therefore, there is a need to improve at least one of these three parameters in order to improve the efficiency of the air vehicles and eVTOLs.

### SUMMARY

Unless otherwise defined, all technical and scientific terms used herein have the same meaning as commonly understood by one of ordinary skill in the art to which this subject matter belongs. Although methods and materials similar or equivalent to those described herein can be used in the practice or testing of the present subject matter, suitable methods and materials are described below. In case of conflict, the patent specification, including definitions, will control. In addition, the materials, methods, and examples are illustrative only and not intended to be limiting.

According to one aspect of the present subject matter, there is provided an electromagnetic propulsion system comprising:
at least one electromagnetic thrustor configured to intake air, ionize the air to produce ionized air, pass the ionized air through at least one electromagnetic field and emit the ionized air in a first direction, to reach acceleration, thereby creating a thrust force in a second direction that is opposite to the first direction, and
an electrostatic repulser surrounding the at least one electromagnetic field, configured to pass at least one inducing element therethrough and control a velocity and acceleration rate of the at least one inducing element,
   wherein a velocity and acceleration rate of the ionized air through the at least one electromagnetic thrustor is induced by the velocity and acceleration rate of the at least one inducing element in the electrostatic repulser.

According to one embodiment, the electromagnetic thrustor comprises a chamber configured to allow passage of air therethrough, an inlet at one side of the chamber and an outlet at an opposite side of the chamber, wherein the inlet is configured to allow intake of air into the chamber, and the outlet is configured to allow emission of the ionized air therethrough.

According to one embodiment, the ionized air is emitted through the outlet in a first direction, and as a result a thrust force in a second direction is generated, when the second direction is opposite to the first direction.

According to one embodiment, the electromagnetic thrustor comprises an inlet turbine installed at the inlet and configured to intake air and push the air into the chamber through the inlet, wherein the inlet turbine comprises an opening configured to let air enter into the inlet turbine, and an exit configured to let the air exit out of the inlet turbine and enter into the chamber through the inlet.

According to one embodiment, the inlet turbine starts to rotate by an electrical motor that is detachably mechanically connected to the inlet turbine, and wherein the motor is energetically connected to a power source configured to provide energy to the motor.

According to one embodiment, the chamber is bent and comprises a bent spot, wherein a part of the chamber that is upstream to the bent spot, including the inlet, is substantially vertical, when the inlet faces upwards; and a part of the chamber that is downstream to the bent spot, including the outlet, is substantially horizontal.

According to one embodiment, the electromagnetic propulsion system further comprising an ionizer configured to ionize the air that flows along the chamber and as a result produce ionized air, wherein the ionizer is positioned downstream to the inlet.

According to one embodiment, the chamber further comprises a magnetic field area configured to comprise the magnetic field therein, downstream the ionizer, thus allowing flow of the ionized air from the ionizer to the magnetic field area, and from the magnetic field area to the outlet and out through the outlet in the first direction.

According to one embodiment, the electromagnetic propulsion system further comprising an alternator that is configured to convert a mechanical energy of the flow of the ionized air out of the magnetic field area to an electrical energy, in a form of electrical current, wherein the electrical current is used for charging a rechargeable power source.

According to one embodiment, the electromagnetic propulsion system further comprising at least one positively charged gas container fluidically connected to an anode located inside the chamber, at an exit of the magnetic field area, and configured to contain a positively charged gas, and at least one negatively charged gas container fluidically connected to a cathode located inside the chamber, at an inlet of the magnetic field area, and configured to contain a negatively charged gas.

According to one embodiment, the electrostatic repulser comprising a plurality of loops that surround the magnetic field area, wherein each loop has a hollow tube-like structure comprising an interior and a wall enclosing the interior, wherein the loop is configured to comprise the inducing element in the interior, wherein the inducing element is configured to pass inside the interior of the loop.

According to one embodiment, the loop comprising an induction section in which the inducing element passes in the first direction, and a return section in which the inducing element passes in the second direction.

According to one embodiment, the induction section of each loop is in proximity to the magnetic field area in a manner that allows induction of the movement of the ionized air through the magnetic field area by the passing of the inducing element through the induction section of the loop, and the return section of each loop is distant from the magnetic field area in a manner that does not allow influence of the passage of the inducing element through the return section of the loop on the movement of the ionized air through the magnetic field area.

According to one embodiment, wherein the inducing element is made of a material that is attracted to a magnetic field.

According to one embodiment, the movement of the inducing element along the induction section is controlled by a sequence of a plurality of magnetic fields that are created along the induction section in the first direction one after the other.

### BRIEF DESCRIPTION OF THE DRAWINGS

Embodiments are herein described, by way of example only, with reference to the accompanying drawings. With specific reference now to the drawings in detail, it is stressed that the particulars shown are by way of example and for purposes of illustrative discussion of the preferred embodiments, and are presented in the cause of providing what is believed to be the most useful and readily understood description of the principles and conceptual aspects of the embodiments. In this regard, no attempt is made to show structural details in more detail than is necessary for a fundamental understanding, the description taken with the drawings making apparent to those skilled in the art how several forms may be embodied in practice.

### In the Drawings:

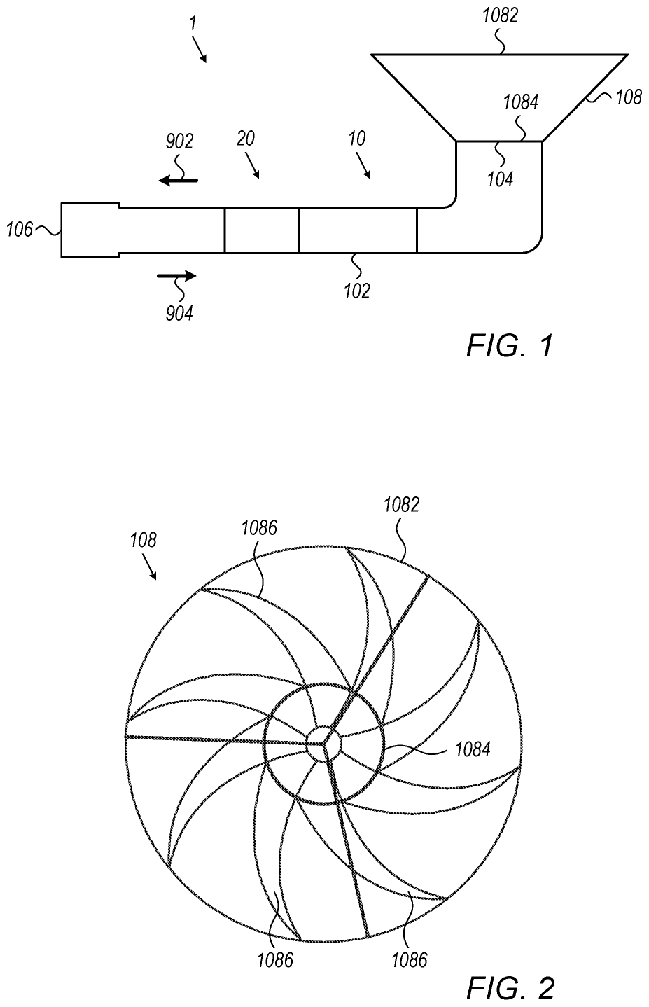

FIG. 1 schematically illustrates, according to an exemplary embodiment, a side view of an electromagnetic propulsion system.

FIG. 2 schematically illustrates, according to an exemplary embodiment, a top view of an inlet turbine.

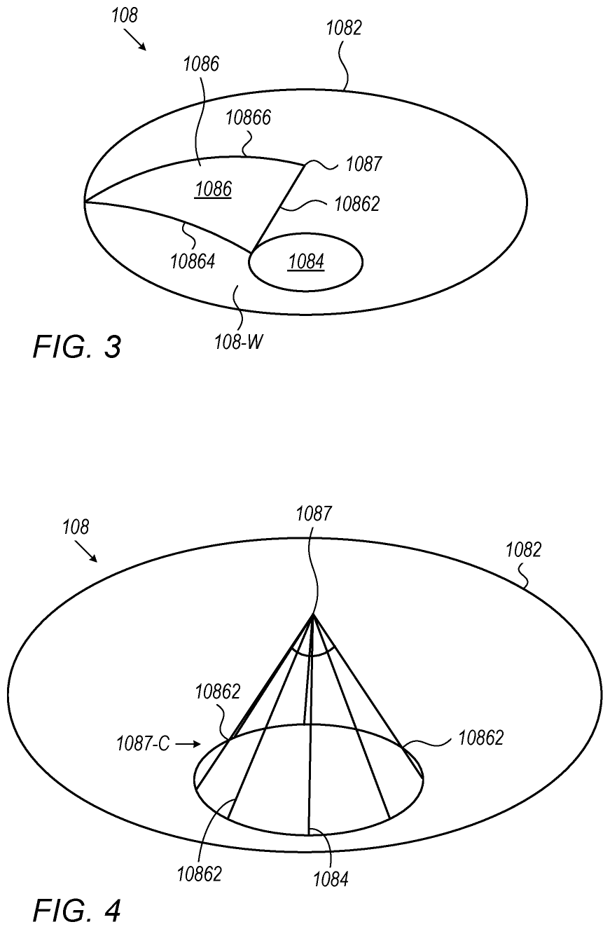

FIG. 3 schematically illustrates, according to an exemplary embodiment, a side perspective view of an inlet turbine and a blade.

FIG. 4 schematically illustrates, according to an exemplary embodiment, a side perspective view of an inlet turbine and a virtual cone formed by first edges of a plurality of blades.

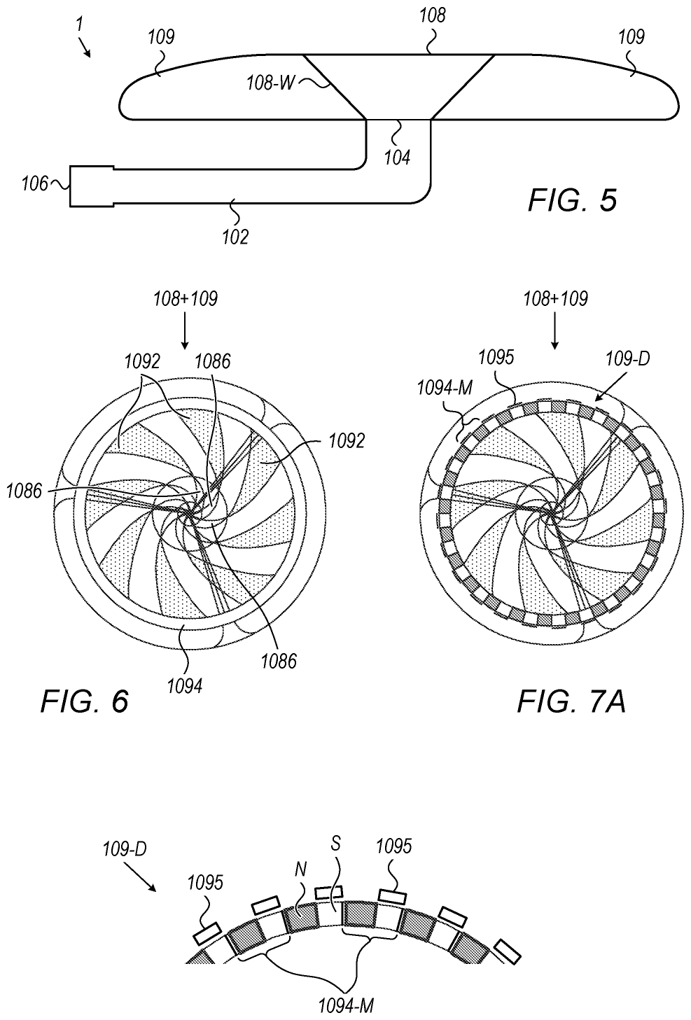

FIG. 5 schematically illustrates, according to an exemplary embodiment, a side view of an electromagnetic propulsion system comprising a ducted fan.

FIG. 6 schematically illustrates, according to an exemplary embodiment, a top view of an inlet turbine and a ducted fan attached to the inlet turbine.

FIG. 7A schematically illustrates, according to an exemplary embodiment, a top view of an inlet turbine and a ducted fan attached to the inlet turbine, the ducted fan comprising a ducted fan driving mechanism.

FIG. 7B schematically illustrates, according to an exemplary embodiment, a top close-up view of a ducted fan driving mechanism.

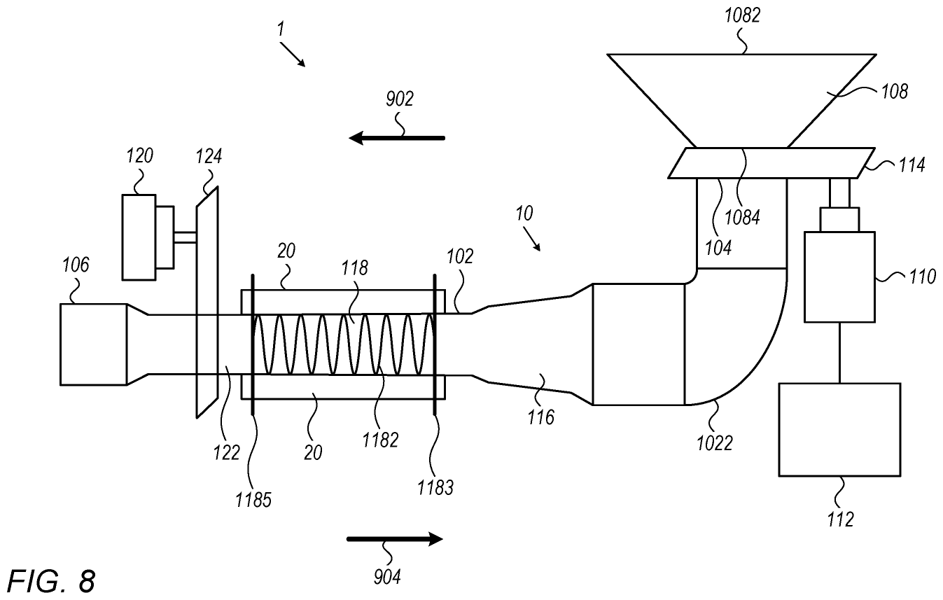

FIG. 8 schematically illustrates, according to an exemplary embodiment, a side transparent view of various embodiment of an electromagnetic propulsion system.

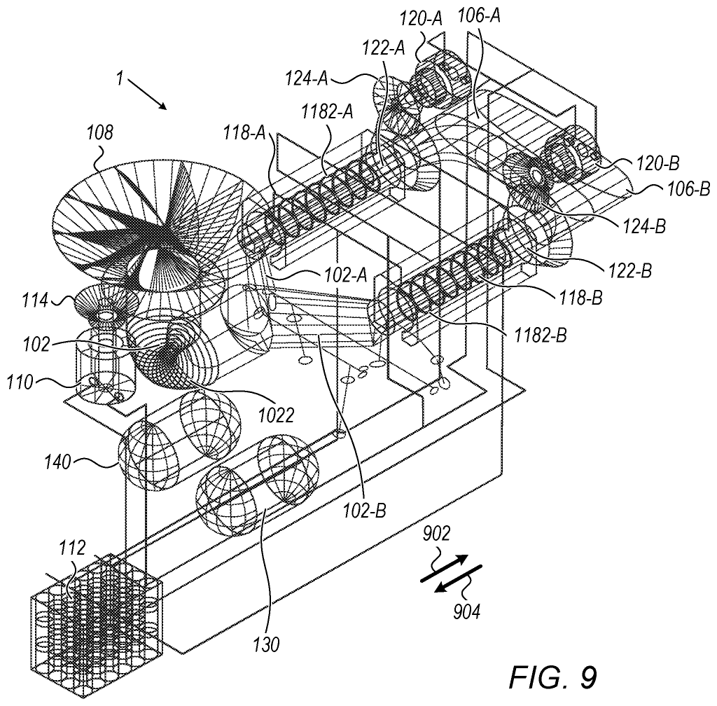

FIG. 9 schematically illustrates, according to an exemplary embodiment, a perspective view of an electromagnetic propulsion system.

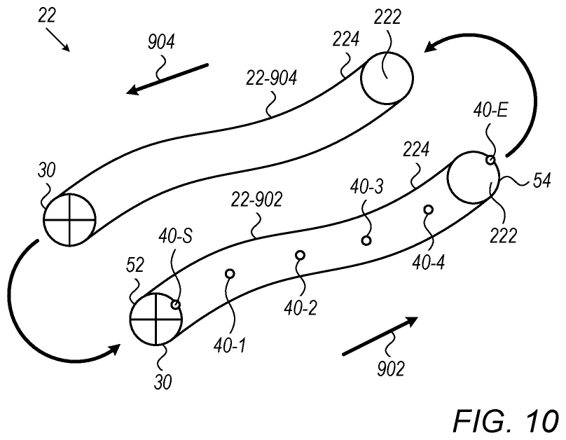

FIG. 10 schematically illustrates, according to an exemplary embodiment, a perspective view of a loop.

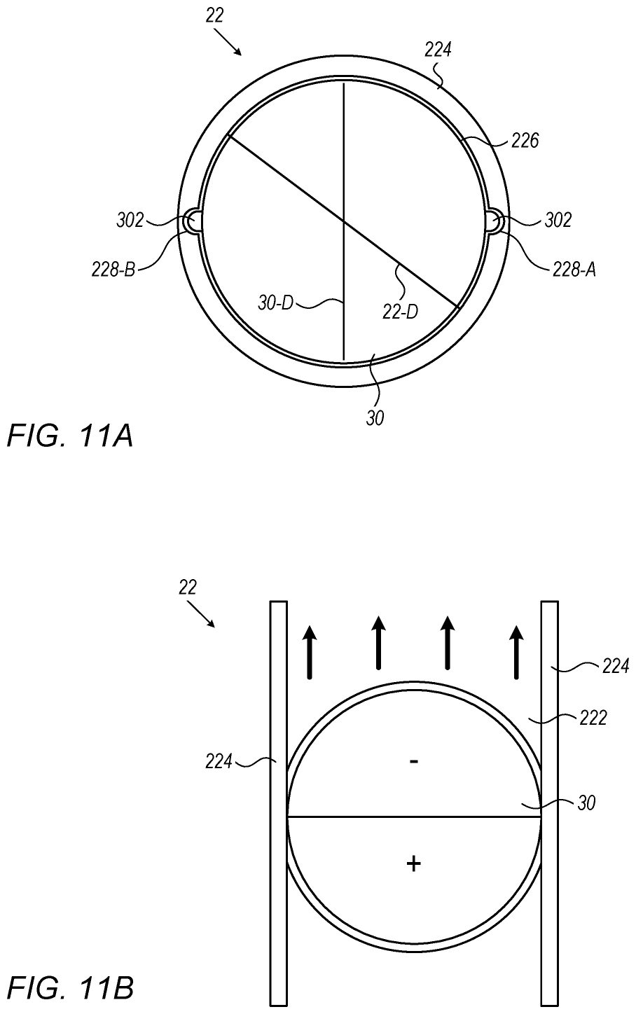

FIGS. 11A-B schematically illustrate, according to an exemplary embodiment, a cross-section view and a top transparent view, respectively, of a loop comprising an inducing element therein.

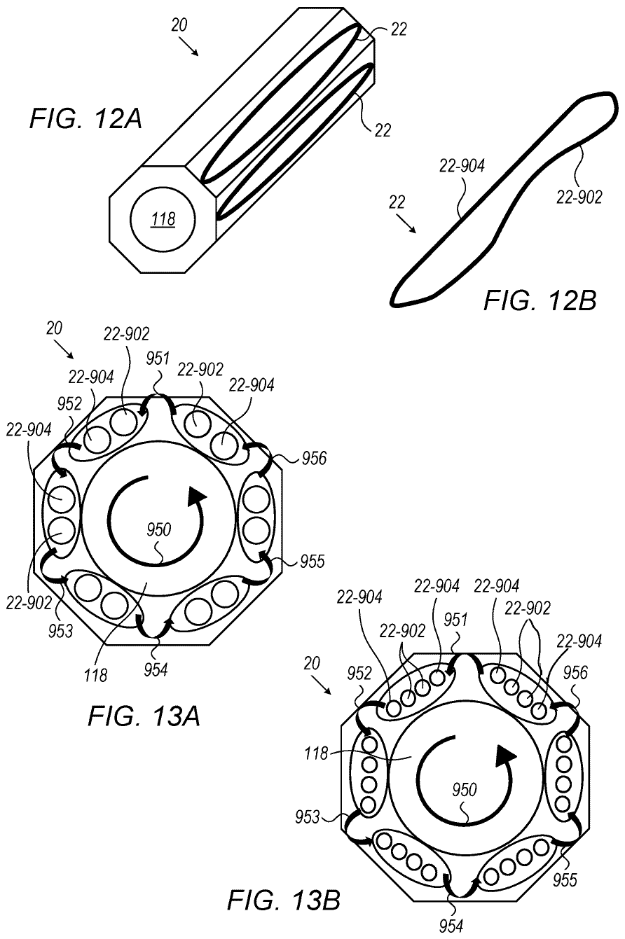

FIG. 12A schematically illustrates, according to an exemplary embodiment, a front perspective transparent view of an electrostatic repulser comprising a plurality of loops.

FIG. 12B schematically illustrates, according to an exemplary embodiment, a side perspective view showing a three-dimensional structure of a loop.

FIGS. 13A-B schematically illustrate, according to an exemplary embodiment, a cross-section view of an electrostatic repulser comprising a plurality of three-dimensional arcular loops.

### DESCRIPTION OF THE PREFERRED EMBODIMENTS

Before explaining at least one embodiment in detail, it is to be understood that the subject matter is not limited in its application to the details of construction and the arrangement of the components set forth in the following description or illustrated in the drawings. The subject matter is capable of other embodiments or of being practiced or carried out in various ways. Also, it is to be understood that the phraseology and terminology employed herein is for the purpose of description and should not be regarded as limiting. In discussion of the various figures described herein below, like numbers refer to like parts. The drawings are generally not to scale.

For clarity, non-essential elements were omitted from some of the drawings.

The present subject matter provides an electromagnetic propulsion system that does not require fossil fuel as a source of energy, has a light weight and capable of providing a vehicle comprising the electromagnetic propulsion system higher acceleration rates and velocities compared to vehicles comprising prior art jet engines.

According to one embodiment, the electromagnetic propulsion system is configured to be part of a vehicle and provide a motive force to the vehicle. According to another embodiment, the electromagnetic propulsion system id configured to provide a lift force to the vehicle. Any type of vehicle is under the scope of the present subject matter. In other words, the electromagnetic propulsion system of the present subject matter is suitable for any type of vehicle: any vehicle configured to move on the ground, for example a car, a motorcycle and the like; any vehicle configured to move on a water surface, for example a boat, a ship and the like; any vehicle configured to fly in the air, for example any vehicle suitable for urban air mobility, a manned aerial vehicle, an unmanned aerial vehicle, a flying car, a flyting bike, a hover-car, a hovercraft, an aircraft, an electric vertical take-off and landing aircraft, any vehicle can functions as an Air-Taxi, a manned drone, an unmanned drone and the like.

In one aspect, the electromagnetic propulsion system comprises:
at least one electromagnetic thrustor configured to intake air, ionize the air to produce ionized air, pass the ionized air through at least one electromagnetic field and emit the ionized air in a first direction, to reach acceleration, thereby creating a thrust force in a second direction that is opposite to the first direction, and
an electrostatic repulser surrounding the at least one electromagnetic field, configured to pass at least one inducing element therethrough and control a velocity and acceleration rate of the at least one inducing element,
wherein a velocity and acceleration rate of the ionized air through the at least one electromagnetic thrustor is induced by the velocity and acceleration rate of the at least one inducing element in the electrostatic repulser.

Referring now to FIG. 1, schematically illustrating, according to an exemplary embodiment, a side view of an electromagnetic propulsion system. FIG. 1 shows the electromagnetic thrustor 10 and the electrostatic repulser 20 of the electromagnetic propulsion system 1.

According to one embodiment, the electromagnetic thrustor 10 comprises a chamber 102 configured to allow passage of air therethrough, an inlet 104 at one side of the chamber 102 and an outlet 106 at an opposite side of the chamber 102. The inlet 104 is configured to allow intake of air into the chamber 102. During passage of the air through the chamber 102, the air is ionized to produce ionized air, and the velocity and acceleration rate of the ionized air can be induced by the electrostatic repulser 20. The outlet 106 is configured to allow emission of the ionized air therethrough in a first direction 902. As a result, a thrust force in a second direction 904 is generated, when the second direction 904 is opposite to the first direction 902. This thrust force can be used for thrusting a vehicle that comprises the electromagnetic propulsion system 1 in the second direction 904.

According to one embodiment, the electromagnetic thrustor 10 comprises an inlet turbine 108 installed at the inlet 104 and configured to intake air and push the air into the chamber 102 through the inlet 104. The inlet turbine 108 comprises an opening 1082 configured to let air enter into the inlet turbine 108, and an exit 1084 configured to let the air exit out of the inlet turbine 108 and enter into the chamber 102 through the inlet 104, when the inlet turbine 108 rotates in a first direction, for example counterclockwise. Any type of inlet turbine 108 is under the scope of the present subject matter. The exemplary inlet turbine 108 shown in FIG. 1 is conical, namely the opening 1082 of the inlet turbine 108 is wider than the exit 1084 of the inlet turbine 108. According to one embodiment, an angle of the conical inlet turbine 108, between the line of the exit 1084 and the inclined profile of the inlet turbine, as shown in FIG. 1, is in a range of substantially 36-60 degrees in a shape of an upside vertical cone.

Referring now to FIG. 2, schematically illustrating, according to an exemplary embodiment, a top view of an inlet turbine. FIG. 2 shows, from above, the opening 1082 of the inlet turbine 108, and the exit 1084 of the inlet turbine 108. Since as can be seen in FIG. 1, according to one embodiment, the inlet turbine 108 has a shape of an upside vertical cone, then the opening 1082 is wider than the exit 1084 of the inlet turbine 108.

According to one embodiment, the inlet turbine 108 comprises a plurality of blades 1086 configured to generate a suction flow of air through the inlet turbine 108 into the chamber 102 through the inlet 104, when the inlet turbine 180 rotates. Any number of blades 1086 that allow the generation of the suction flow of air that is necessary for the operation of the electromagnetic propulsion system 1 is under the scope of the present subject matter. An exemplary number of blades 1086 that is shown in FIG. 2 is eight. However, the exemplary number of blades 1086 should not be considered as limiting the scope of the present subject matter. Any number of blades 1086 is under the scope of the present subject matter. According to one embodiment, the number of blades 1086 is in the range of 8-10 blades 1086. According to another embodiment, the number of blades is eight. According to yet another embodiment, the number of blades 1086 is nine. According to still another embodiment, the number of blades 1086 is ten.

Referring now to FIG. 3, schematically illustrating, according to an exemplary embodiment, a side perspective view of an inlet turbine and a blade. FIG. 3 illustrates additional embodiments of the blades 1086 and their relation with the inlet turbine 108, by focusing on one blade 1086. As can be seen in FIG. 3, the inlet turbine 108 comprises a wall 108-W between the opening 1082 and the exit 1084 of the inlet turbine 108. According to one embodiment, the blade 1086 comprises a first edge 10862, a second edge 10864 and a third edge 10866. According to another embodiment, the blade 1086 extends from the wall 108-W of the inlet turbine 108, when the second edge 10864 of the blade 1086 resides on the wall 108-W between a circumference of the opening 1082 and a circumference of the exit 1084 of the inlet turbine 108. The first edge 10862 of the blade 1086 extends from the circumference of the exit 1084 toward the opening 1082 and ends in a point termed apex 1087. The third edge 10866 of the blade extends from the apex 1087 to the circumference of the opening 1082 and attaches the second edge 10864 on the circumference of the opening 1082. Thus, the blade 1086 has a substantially triangular shape.

Returning now to FIG. 2. According to one embodiment, the blades 1086 are tilted and curved, in order to form an aerodynamic shape and any required turbine blade airfoil that allows suction of the air by the inlet turbine 108, when the inlet turbine 108, including the blades 1086, rotates, as described above. According to another embodiment, the blades 1086 are configured to provide the necessary vertical airfoil that is required for the operation of the electromagnetic propulsion system 1.

Referring now to FIG. 4, schematically illustrating, according to an exemplary embodiment, a side perspective view of an inlet turbine and a virtual cone formed by first edges of a plurality of blades. FIG. 4 illustrates a virtual cone 1087-C that is formed by the first edges 10862 of the plurality of blades 1086 of the inlet turbine 108. The base of the virtual cone 1087-C is an area of the exit 1084 of the inlet turbine 108, the first edges 10862 of the plurality of blades 1086 are lines that extend from the circumference of the exit 1084, which is the base of the virtual cone 1087-C, when all the first edges 10862 are connected at the apex 1087. It should be noted that the virtual cone 1087-C allows passage of air therethrough because there are gaps between the blades 1086 through which air can pass when the inlet turbine 108 rotates.

As mentioned above, rotation of the inlet turbine 108 generates a suction flow of air through the inlet turbine 108 into the chamber 102 through the inlet 104. According to one embodiment, the suction flow of air that is generated by the rotation of the inlet turbine 108 gives rise to the thrust force that allows movement forward, for example, of the a vehicle that comprises the electromagnetic propulsion system 1. According to another embodiment, the suction flow of air that is generated by the rotation of the inlet turbine 108 is not strong enough to provide an elevation force that can elevate the vehicle, even though the opening 1082 of the inlet turbine 108 is directed upwards. For this, an addition of a propeller, or in other words-a ducted fan, to the electromagnetic propulsion system 1 is needed.

Referring now to FIG. 5, schematically illustrating, according to an exemplary embodiment, a side view of an electromagnetic propulsion system comprising a ducted fan. The electromagnetic propulsion system 1 that is illustrated in FIG. 5 is similar to the electromagnetic propulsion system 1 that is illustrated in FIG. 1, except that it comprises a ducted fan 109. According to one embodiment, the ducted fan 109 is attached to the inlet turbine 108. According to another embodiment, the ducted fan 109 is configured to rotate together with the inlet turbine 108. According to yet another embodiment, the ducted fan 109 is wider than the inlet turbine 108. According to still another embodiment, the ducted fan 109 is three times wider than the inlet turbine 108. According to a further embodiment, the ducted fan 109 is four times wider than the inlet turbine 108. According to yet a further embodiment, the ducted fan 109 is 3 to 4 times wider than the ducted fan. According to an additional embodiment, the ducted fan 109 is configured provide an elevation force that can elevate the vehicle that comprises the electromagnetic propulsion system 1. Any type of ducted fan 109 is under the scope of the present subject matter.

Referring now to FIG. 6, schematically illustrating, according to an exemplary embodiment, a top view of an inlet turbine and a ducted fan attached to the inlet turbine. FIG. 6 shows the inlet turbine 108 and the blades 1086, as shown in FIG. 2. According to the present embodiment, a ducted fan 109 is attached to the inlet turbine 108. According to one embodiment, the ducted fan 109 comprises a plurality of ducted fan blades 1092. According to another embodiment, a number of the ducted fan blades 1092 is similar to the number of the blades 1086. According to yet another embodiment, the ducted fan blades 1092 are extensions of the blades 1086. In other words, each ducted fan blade 1092 is an extension of a corresponding blade 1086.

Returning now to FIG. 5. FIG. 5 shows the wall 108-W of the inlet turbine 108. Each blade 1086 is attached to an inner surface of the wall 108-W and each corresponding ducted fan blade 1092 is attached to an outer surface of the wall 108-W at the same place as the ducted fan blade 1092.

Returning now to FIG. 6. According to one embodiment, the ducted fan blades 1092 are tilted and curved, in order to form an aerodynamic shape and any required ducted fan blade airfoil that allows generation of an elevation force when the ducted fan 109 rotates.

According to one embodiment, the ducted fan 109 comprises a circle 1094 that encloses the ducted fan blades 1092. Another embodiment of the circle 1094 is shown in FIGS. 7A-B.

Referring now to FIG. 7A, schematically illustrating, according to an exemplary embodiment, a top view of an inlet turbine and a ducted fan attached to the inlet turbine, the ducted fan comprising a ducted fan driving mechanism. The inlet turbine 108 and the ducted fan 109 shown in FIG. 7A are similar to the inlet turbine 108 and the ducted fan 109 shown in FIG. 6. However, FIG. 7A additionally shows an embodiment of the ducted fan 109 comprising a ducted fan driving mechanism 109-D. According to one embodiment, the ducted fan driving mechanism 109-D is configured to drive rotation of the ducted fan 109. According to another embodiment, the ducted fan driving mechanism 109-D is configured to start rotation of the ducted fan 109 when the ducted fan 109 does not rotate. According to yet another embodiment, the ducted fan driving mechanism 109-D is configured to drive rotation of the ducted fan 109 during rotation of the ducted fan 109. According to a further embodiment, the ducted fan driving mechanism 109-D can replace a motor 110 described hereinafter.

According to one embodiment, the ducted fan driving mechanism 109-D comprises a plurality of circle magnets 1094-M arranged on the circle 1094 and a plurality of driving electromagnets 1095 arranged aside the circle 1094. A close up view of the ducted fan driving mechanism 109-D is illustrated in FIG. 7B.

Referring now to FIG. 7B, schematically illustrating, according to an exemplary embodiment, a top close-up view of a ducted fan driving mechanism. FIG. 7B shows a part of the circle 1094. A plurality of circle magnets 1094-M is arranged on the circle 1094. Each circle magnet 1094-M comprises two magnetic poles-North designated with N and south designated with S. In addition, a plurality of driving electromagnets 1095 is arranged aside the circle 1094. According to one embodiment, the distance of the driving electromagnets 1095 and the strength of the magnetic fields of the driving electromagnets 1095 and the strength of the magnetic fields of the circle magnets 1094-M enable attraction, or repulsion, of the circle magnets 1094-M by the driving electromagnets 1095.

According to one embodiment, each driving electromagnet 1095 is configured to change its polarity between North and South. According to another embodiment, the driving electromagnets 1095 is configured to change the polarity of the driving electromagnets 1095 in synchrony. In other words, the plurality of driving electromagnets 1095 is configured to change the polarity of individual driving electromagnets 1095 simultaneously. As a results of the changing of the polarity of the driving electromagnets 1095 the circle 1094 rotates because of attraction of the circle magnets 1094-M by the driving electromagnets 1095. For example, when a driving electromagnet 1095 has a North polarity, the south S pole of an adjacent circle electromagnet 1095 is attracted towards the circle electromagnet 1094-M having a North pole. Thus, the changing of the polarity of the driving electromagnets 1095 drives rotation of the circle 1094. The rate, or frequency, of the changing of the polarity of the driving electromagnets 1095 determines the velocity of the rotation of the circle 1094, together with the entire ducted fan 109.

Referring now to FIG. 8, schematically illustrating, according to an exemplary embodiment, a side transparent view of various embodiment of an electromagnetic propulsion system. The electromagnetic propulsion system 1 shown in FIG. 8 is similar to the electromagnetic propulsion system 1 shown in FIG. 1, but with some additional embodiments.

Some embodiments relates to a mechanism for starting rotation of the inlet turbine 108. Any type of mechanism for starting rotation of the inlet turbine 108 is under the scope of the present subject matter. According to one embodiment, the mechanism for starting rotation of the inlet turbine 108 is the ducted fan driving mechanism 109-D, described above. According to another exemplary embodiment, the inlet turbine 108 shown in FIG. 8 starts to move by a motor 110 mechanically connected to the inlet turbine 108. Any type of motor 110 is under the scope of the present subject matter, except a motor 110 that is based on combustion of fossil fuels, like petrol-based aviation fuel, gasoline and the like, in order to keep the electromagnetic propulsion system 1 and the vehicle comprising the electromagnetic propulsion system 1 at low weight. Another reason for not using a motor 110 that is based on combustion of fossil fuels is to be able to use the motor 110 in an electromagnetic propulsion system 1 that is installed in a fully electrical vehicle. Thus, for example, the motor 110 is an electrical motor 110.

According to one embodiment, the motor 110 is energetically connected to a power source 112 configured to provide energy to the motor 110. Any type of power source 112 is under the scope of the present subject matter. For example, the power source 112 is an electrical power source 112 that is electrically connected to the motor 110, and the motor 110 is an electrical motor 110.

Any mechanism for mechanically connecting the motor 110 to the inlet turbine 108 is under the scope of the present subject matter. According to the exemplary embodiment shown in FIG. 8, the motor 110 is mechanically connected to the inlet turbine 108 with a motor-turbine connector 114 in a form of a gear system. Thus, rotation of a gear of the motor 110 causes rotation of a gear of the inlet turbine 108.

According to one embodiment, the inlet turbine 108 is detachably mechanically connected to the motor 110. Thus, according to this embodiment, the inlet turbine 108 can be either mechanically connected to, or mechanically disconnected from, the motor 110. When the inlet turbine 180 is mechanically connected to the motor 110, the rotation of the inlet turbine 108 is driven by the motor 110. On the other hand, when the inlet turbine is mechanically disconnected from motor 110, the inlet turbine 108 can for example rotate when the motor 110 is shut off. This occurs, for example, when the velocity and acceleration rate of the ionized air are induced by the electrostatic repulser 20, as described hereinafter.

To summarize the function of the motor 110, the motor 110 is configured to start rotation of the inlet turbine 108. Thus, the motor 110 is configured to connect to the inlet turbine 108 when there is a need to start rotation of the inlet turbine. When the inlet turbine 108 rotates by a force exerted by the flow of air and ionized air, there is no to connect the motor 110 to the inlet turbine 108, and thus in this case the motor 110 is configured to disconnect from the inlet turbine 108.

As mentioned above, the outlet 106 is configured to allow emission of the ionized air therethrough in a first direction 902. Thus, the direction of movement of air through the chamber 102 is defined as first direction 902. Accordingly, a position of components or parts in the electromagnetic propulsion system 1 can be defined in relation to the first direction 902. Because air flows from the inlet 104 toward the outlet 106 in the first direction 902, the inlet 104 is considered as upstream to the outlet 106, and the outlet 106 is considered as downstream to the inlet 104.

According to one embodiment, the chamber 102 is substantially straight. For example, the entire chamber 102 is horizontal. According to another embodiment, the chamber 102 is bent, as shown in FIG. 8. According to this embodiment, the chamber 102 comprises a bent spot 1022, when a part of the chamber 102 that is upstream to the bent spot 1022, including the inlet 104, is substantially vertical, when the inlet 104 faces upwards; and a part of the chamber 102 that is downstream to the bent spot 1022, including the outlet 106, is substantially horizontal.

According to one embodiment, the electromagnetic propulsion system 1 comprises an ionizer 116 configured to ionize the air that flows along the chamber 102 and as a result produce ionized air. According to another embodiment, the ionizer 116 is positioned downstream to the inlet 104. According to yet another embodiment, when the chamber 102 is bent, the ionizer 116 is positioned downstream to the bent spot 1022.

Any mechanism for ionizing the air by the ionizer 116 is under the scope of the present subject matter. Some exemplary embodiments of the mechanism for ionizing the air are described hereinafter.

According to one embodiment, the chamber 102 comprises a magnetic field area 118 configured to comprise a magnetic field therein, downstream the ionizer 116. Thus, the ionized air flows from the ionizer 116 to the magnetic field area 118. Any mechanism for generating the magnetic field in the magnetic field area 118 is under the scope of the present subject matter. For example, the magnetic field area 118 can comprise a permanent magnet. As a result, the magnetic field area 118 comprises a permanent magnetic field. In another example, the magnetic field area 118 comprises an electromagnet 1182, as shown in FIG. 8. Any type of electromagnet 1182 is under the scope of the present subject matter. For example, the electromagnet 1182 shown in FIG. 8 is in a form of a coil that surrounds a circumference of the magnetic field area 118 of the chamber 102. The electromagnet 1182 allows generation of a magnetic field in the magnetic field area 118 at desired times by letting an electrical current to flow through the electromagnet 1182, while in other times, for example when there is no need for a magnetic field in the magnetic field area 118, there is no flow of an electrical current through the electromagnet 1182.

Due to the position of the magnetic field area 118 downstream to the ionizer 116, the ionized air that flows through the magnetic field area 118 is exposed to a magnetic field. In other words, during operation of the electromagnetic propulsion system 1, when the magnetic field area 118 comprises an electromagnet 1182, there is a need to turn on the electromagnet 1182 by letting an electrical current to flow through the electromagnet 1182.

According to one embodiment, the outlet 106 is positioned downstream to the magnetic field area 118. Thus, after exiting the magnetic field area 118, the ionized air flows to the outlet 106 and out through the outlet 106 in the first direction 902, thereby creating the thrust force in the second direction 904 that is opposite to the first direction 902.

According to one embodiment, the electromagnetic propulsion system 1 comprises an alternator 120 that is configured to convert a mechanical energy of the flow of the ionized air out of the magnetic field area 118 to an electrical energy, in a form of electrical current. Any mechanism for converting the mechanical energy of the flow of the ionized air to an electrical current is under the scope of the present subject matter. For example, as shown in FIG. 8, the electromagnetic propulsion system 1 comprises a fan 122 in the chamber 102, downstream to the magnetic field zone 118, wherein the fan 122 is mechanically connected to the alternator 120.

Any mechanism for mechanically connecting the fan 122 to the alternator 120 is under the scope of the present subject matter. According to the exemplary embodiment shown in FIG. 1, the fan 122 is mechanically connected to the alternator 120 with a fan-alternator connector 124 in a form of a gear system. Thus, rotation of a gear of the fan 122 causes rotation of a gear of the alternator 120.

According to one embodiment, the electrical current that is produced by the alternator 120 is used for supplying the needed electrical energy for the operation of the electromagnetic propulsion system 1. According to another embodiment, the electrical current that is generated by the alternator 120 is used for charging a rechargeable power source, for example a rechargeable electrical battery.

As mentioned above, when the ionized air is emitted from the outlet 106 in the first direction 902, a thrust force in the second direction 904, that is opposite to the first direction 902, is created. As a result, a vehicle that comprises the electromagnetic propulsion system 1 moves in the second direction 904.

Referring now to FIG. 9, schematically illustrating, according to an exemplary embodiment, a perspective view of an electromagnetic propulsion system. FIG. 9 shows some additional embodiments of the electromagnetic propulsion system 1, as well as some additional optional components of the electromagnetic propulsion system 1.

According to one embodiment, shown in FIG. 9, the chamber 102 is split to a first chamber 102-A, and a second chamber 102-B. According to one embodiment, the chamber 102 is split downstream to the inlet 104. According to another embodiment, the chamber 102 is split downstream to the bent spot 1022.

According to the embodiment of the chamber 102 that is split to a first chamber 102-A and a second chamber 102-B, the electromagnetic propulsion system 1 comprises a first ionizer 116-A configured to ionize the air that flows along the first chamber 102-A and a second ionizer 116-B configured to ionize the air that flows along the second chamber 102-B; a first magnetic field area 118-A, comprising a first electromagnet 1182-A, at the first chamber 102-A, and a second magnetic field area 118-B comprising a second electromagnet 1182-B at the second chamber 102-B; a first electrostatic repulser 20-A surrounding the first magnetic field area 118-A, and a second electrostatic repulser 20-B surrounding the second magnetic field area 118-B; a first alternator 120-A comprising a first fan 122-A and a first fan-alternator connector 124-A at the first chamber 102-A, and a second alternator 120-B comprising a second fan 112-B and a second fan-alternator connector 124-B at the second chamber 102-B; and a first outlet 106-A at an opposite side of the first chamber 102-A relative to the inlet 104, and a second outlet 106-B at an opposite side of the second chamber 102-B relative to the inlet 104.

One mechanism for ionizing the air that is shown in FIG. 9 is enriching the air with at least one positively charged gas and at least one negatively charged gas. Thus, according to one embodiment, the electromagnetic propulsion system 1 further comprises at least one positively charged gas container 130 fluidically connected to the chamber 102 and configured to contain a positively charged gas, and at least one negatively charged gas container 140 fluifically connected to the chamber 102 and configured to contain a negatively charged gas. Any type of positively charged gas, in any concentration in a mixture of gases is under the scope of the present subject matter, for example argon, or hydrogen. Thus, according to one embodiment, the positively charged gas container 130 is configured to contain argon, or hydrogen, in any form: solid, liquid, or gas. According to one embodiment, the positively charged gas container 130 is fluidically connected to an anode located inside the chamber 102, at an exit of the magnetic field area 118. Similarly, any type of negatively charged gas, in any concentration in a mixture of gases, is under the scope of the present subject matter, for example xenon, or oxygen. Thus, according to one embodiment, the negatively charged gas container 140 is configured to contain xenon, or oxygen, in any form: solid, liquid, or gas. According to one embodiment, the negatively charged gas container 140 is fluidically connected to a cathode located inside the chamber 102, at an inlet of the magnetic field area 118.

As mentioned above, the velocity and acceleration rate of the ionized air through the electromagnetic thrustor 10, is induced by the velocity and acceleration rate of at least one inducing element that passes through the electrostatic repulser 20. As can be seen in FIG. 8, the electrostatic repulser 20 surrounds the chamber 102, at the magnetic field area 118. Thus, when the at least one inducing element passes through the electrostatic repulser 20, it influences the flow of the ionized air through the magnetic field area 118. In other words, the flow of the ionized air through the magnetic field area 118 mimics the passage of the at least one inducing element through the electrostatic repulser 20. For example, when the at least one inducing element accelerates, the ionized air accelerates accordingly, and when the at least one inducing element decelerates, the ionized air decelerates accordingly.

Referring now to FIG. 10, schematically illustrating, according to an exemplary embodiment, a perspective view of a loop. The loop 22 is a basic unit of the electrostatic repulser 20. According to one embodiment, the electrostatic repulser 20 comprises a plurality of loops 22 that surround the magnetic field area 118. According to another embodiment, the electrostatic repulser 20 comprises at least one pair of loops 202, when each pair comprises two loops 22. The loop 22 has a hollow tube-like structure comprising an interior 222 and a wall 224 enclosing the interior 222. The loop 22 is also configured to comprise an inducing element 30 in the interior 222, when the inducing element 30 is configured to pass inside the interior 222 of the loop 22.

Referring now to FIGS. 11A-B, schematically illustrating, according to an exemplary embodiment, a cross-section view and a top transparent view, respectively, of a loop comprising an inducing element therein. FIG. 11A shows the wall 224 of the loop 22 and the interior 222 of the loop 224, and the inducing element 30 inside the interior 222 of the loop 22. According to one embodiment, the inducing element 30 has s spherical structure that corresponds to a spherical diameter of the loop 22. According to another embodiment, a diameter 30-D of the inducing element 30 is smaller than a diameter 222-D of the interior 222 of the loop 22. As a result, there is a gap 225 between the inducing element 30 and the wall 224 of the loop 22. The purpose of this gap 226 is to reduce friction forces between the inducing element 30 and the wall 224 when the inducing element 30 passes inside the loop 22.

Still referring to FIG. 11A, according to one embodiment, the inducing element 30 comprises a ring 302 that protrudes from a circumference of the inducing element 30, and along the loop 22, on a side of the wall 224 that faces the interior 222 there are a first groove 228-A and a second groove 228-B, that are parallel to each other, and are configured to accommodate the ring 302 of the inducing element 30, in a manner that allows gliding of the ring 302 in the first groove 228-A and the second groove 228-B when the inducing element 30 passes inside the loop 22. According to one embodiment, a width of the ring 302 is smaller than a width of the first groove 228-A and the second groove 228-B, and as a result there is a gap 226 between the ring 302 and the first groove 228-A and the second groove 228-B. This gap 226 also reduces friction forces between the ring 302 and the first groove 228-A and the second groove 228-B when the ring 302 glides in the first groove 228-A and the second groove 228-B.

Returning now to FIG. 10. According to one embodiment, the loop 22 comprises two sections that differ one from the other in the direction in which the inducing element 30 passes through the loop 22. An induction section 22-902 of the loop 22 is a section in which the inducing element 30 passes through the loop 22 in the first direction 902, which is similar to the direction of the movement of air, and ionized air, through the chamber 102, as shown in FIGS. 8 and 9. A return section 22-904 of the loop 22 is a section in which the inducing element 30 passes through the loop 22 in the second direction 904, which is opposite to the first direction 902.

According to one embodiment, when the plurality of loops 22 surround the magnetic field area 118, the induction section 22-902 of each loop 22 is in proximity to the magnetic field area 118 in a manner that allows induction of the movement of the ionized air through the magnetic field area 118 by the passing of the inducing element 30 through the induction section 22-902 of the loop 22, and the return section 22-904 of each loop 22 is distant from the magnetic field area 118 in a manner that does not allow influence of the passage of the inducing element 30 through the return section 22-904 of the loop 22 on the movement of the ionized air through the magnetic field area 118.

According to one embodiment, the electromagnetic propulsion system 1 is configured to control a movement of the inducing element 30 through the induction section 22-902. According to another embodiment, the electromagnetic propulsion system 1 is configured to accelerate the movement of the inducing element 30 through the induction section 22-902. According to yet another embodiment, the electromagnetic propulsion system 1 is configured to decelerate the movement of the inducing element 30 through the induction section 22-902. Any mechanism for achieving these embodiments is under the scope of the present subject matter. An exemplary mechanism is described hereinafter.

Still referring to FIG. 10. According to one embodiment, the movement of the inducing element 30 along the induction section 22-902 is controlled by a sequence of a plurality of magnetic fields that are created along the induction section 22-902 in the first direction 902 one after the other. According to this embodiment, a movement of the inducing element 30 can be influenced by a magnetic field. Any embodiment that allows influence of the magnetic field on the movement of the inducing element 30 is under the scope of the present subject matter. For example, the inducing element 30 is made of a material that is attracted to a magnetic field, for example a ferromagnetic metal. Any type of ferromagnetic metal is under the scope of the present subject matter, for example, iron, nickel, cobalt, gadolinium, dysprosium, an alloy that contains at least one ferromagnetic metal, like steel, and the like. Another example is an inducing element 30 that is a magnet, thus comprising a North pole and a South pole.

According to this embodiment, the induction section 22-902 comprises a start point 52 and an end point 54, wherein the inducing element 30 passes through the induction section 22-902 from the start point 52 to the end point 54 in the first direction 902. According to another embodiment, the induction section 222-902 comprises a start electromagnet 40-S positioned at the start point 52 and an end electromagnet 40-E positioned at the end point 54. The start electromagnet 40-S and the end electromagnet 40-E, and any additional optional electromagnet 40 that is described hereinafter are configured to be activated by providing an electrical current to the electromagnet 40. When the electromagnet is switched-on, namely connected to an electrical power source, a magnetic field is generated by the electromagnet 40; and when the electromagnet is switched-off, namely disconnected from the electrical power source, the magnetic field of the electromagnet dissipates and no magnetic field is generated by the electromagnet 40. In addition, the start electromagnet 40-S and the end electromagnet 40-E are configured to be activated in sequence, as follows; start electromagnet 40-S switched-on for a period of time, start electromagnet 40-S switched-off, end electromagnet 40-E switched-on for a period of time, end electromagnet 40-E switched-off. As a result of this sequential switching-on and switching-off of the start electromagnet 40-S and the end electromagnet 40-E, a sequence of magnetic fields is generated—firstly at the position of the start electromagnet 40-S, and then at the position of the end electromagnet 40-E. As mentioned above, this sequence of generation of magnetic field is in the first direction 902—the start electromagnet 40-S to the end electromagnet 40-E. When an inducing element 30 is positioned in a vicinity of the start electromagnet 40-S, the inducing element 30 is attracted toward the magnetic field of the start electromagnet 40-S. Then, after the start electromagnet 40-S is switched-off and the end electromagnet 40-E is switched-on, the inducing element 30 is attracted by the magnetic field that is generated in the position of the end electromagnet 40-E, and moves towards the end electromagnet 40-E through the induction section 22-902 in first direction 902. This embodiment is relevant when the force of the magnetic field of the end electromagnet 40-E is strong enough to attract the inducing element 30 when the inducing element 30 is positioned aside the start electromagnet 40-S. However, there may be cases when the force of the magnetic field of the end electromagnet 40-E is not strong enough to attract the inducing element 30 that is aside the start electromagnet 40-S, for example when the distance between the start electromagnet 40-S and the end electromagnet 40-E is too long, when the force of the magnetic field that is generated by the end electromagnet 40-E is too low, and the like. In order to overcome this situation, the present subject matter provides the following embodiment.

Still referring to FIG. 10, according to one embodiment, the induction section 22-902 comprises, in addition to the start electromagnet 40-S and the end electromagnet 40-E, at least one additional electromagnet 40 in-between the start electromagnet 40-S and the end electromagnet 40-E. For example, FIG. 10 illustrates four additional electromagnets 40 between the start electromagnet 40-S and the end electromagnet 40-E—first electromagnet 40-1, second electromagnet 40-2, third electromagnet 40-3 and fourth electromagnet 40-4. It should be noted that this amount of four additional electromagnets 40 is only exemplary, and that any number of additional electromagnets 40 is under the scope of the present subject matter.

According to one embodiment, the additional electromagnets 40 are also configured to switch-on and switch-off in sequence, as described above for the start electromagnet 40-S and the end electromagnet 40-E. An example of the events of switching-on and switching-off of the electromagnets 40 is as follows: start electromagnet 40-S switched-on for a period of time, start electromagnet 40-S switched-off, first electromagnet 40-1 switched-on for a period of time, first electromagnet 40-1 switched-off, second electromagnet 40-2 switched-on for a period of time, second electromagnet 40-2 switched-off, third electromagnet 40-3 switched-on for a period of time, third electromagnet 40-3 switched-off, fourth electromagnet 40-4 switched-on for a period of time, fourth electromagnet switched-off, end electromagnet 40-E switched-on for a period of time, end electromagnet 40-E switched-off. As a result, a kind of a wave of a magnetic field moves from the start electromagnet 40-S towards the end electromagnet 40-E, through the additional electromagnet 40, in the first direction 902, and as a result of this wave of magnetic field, the inducing element 30 moves though the induction section 22-902 in the first direction 902.

The aforementioned embodiments of the electromagnets 40 of the induction section 22-902 of the loop 22 provide a mechanism of controlling the movement of the inducing element 30 through the induction section 22-902 by controlling the sequence of switching-on and switching-off of the electromagnets 40. Thus, the velocity of the magnetic field wave along the induction section 22-902, and the acceleration and deceleration of the magnetic field wave, can be controlled, thereby controlling accordingly the movement of the inducing element 30 through the induction section 22-902 of the loop 22.

Still referring to FIG. 10, according to one embodiment, after the inducing element 30 reaches the end point 54 of the induction section 22-902, where the end electromagnet 40-E is positioned, the inducing element 30 enters the return section 22-904 of the loop 22. In the return section 22-904, the inducing element 30 moves in the second direction 904 back towards the start point 52 of the induction section 22-902, and the sequence of switching-on and switching-off of the electromagnets 40 can start again. According to an exemplary embodiment, the inducing element 30 moves in the second direction 904 in a linear pattern. According to another embodiment, there is no need to control the movement of the inducing element 30 through the return section 22-904, because, for example, the inducing element 30 enters the return section 22-904 in high velocity, and it simply moves in the second direction 904 by a force of inertia. According to yet another embodiment, switching-on the start electromagnet 40-S when the inducing element 30 moves through the return section 22-904 can cause attraction of the inducing element 30 towards the start electromagnet 40-S.

Still referring to FIG. 10. According to one embodiment, the inducing element 30 is electrically charged. According to another embodiment, the loop 22 has a certain three-dimensional configuration that is represented by a curved three-dimensional arcular structure of the loop 22 in FIG. 10. This certain three-dimensional configuration of the plurality of loops 22 that surround the magnetic field area 118 of the chamber 102 allows induction of the movement of the ionized air through the magnetic field area 118 by the passing of the electrically charged inducing elements 30 through the plurality of induction sections 22-902 of the plurality of loops 22. Thus, the movement of the electrically charged inducing elements 30 through the plurality of induction sections 22-902 of the plurality of loops 22 in the certain three-dimensional configuration, induces the flow of the ionized air in the magnetic field area 118 of the chamber 102. In other words, the movement of the ionized air mimics the movement of the electrically charged induction element 30. When the electrically charged induction elements 30 accelerate, the ionized air inside the chamber 102 similarly accelerates, and when the electrically charged induction elements 30 decelerate, the ionized air similarly decelerates.

Referring now to FIG. 12A, schematically illustrating, according to an exemplary embodiment, a front perspective transparent view of an electrostatic repulser comprising a plurality of loops. As can be seen in FIG. 12, according to one embodiment, the electrostatic repulser 20 surrounds the magnetic field area 118. According to another embodiment, the electrostatic repulser 20 comprises a plurality of loops 22 therewithin. Even though only two loops 22 are illustrated in FIG. 12, this number of loops is only exemplary and should not be considered a limiting the scope of the present subject matter.

Referring now to FIG. 12B, schematically illustrating, according to an exemplary embodiment, a side perspective view showing a three-dimensional structure of a loop. FIG. 12B shows an exemplary three-dimensional structure of the loop 22. According to one embodiment, the induction section 22-902 of the loop 22 has an arcular structure. According to another embodiment, the arcular structure of the induction section 22-902 is three-dimensional. In other words, the induction section 22-902 is three-dimensionally arcular in an X-Y plane, in an X-Z plane and in a Y-Z plane, when a three-dimensional space is defined by an X-axis, a Y-axis and a Z-axis. According to yet another embodiment, the three-dimensional arcular structure of the induction section 22-902 facilitates induction of the movement of air and ionized air, through the magnetic field area 118 by the passage of the inducing element 30 through the three-dimensionally arcular induction section 22-902.

According to another embodiment, the return section 22-904 of the loop 22 does not have a specific structure, because passage of the inducing element 30 through the return section 22-904 does not influence the movement of air, and ionized air, through the magnetic field area 118. According to another embodiment, shown in FIG. 12B, the return section 22-904 is linear.

Referring now to FIGS. 13A-B, schematically illustrating, according to an exemplary embodiment, a cross-section view of an electrostatic repulser comprising a plurality of three-dimensional arcular loops. As can be seen in FIG. 13A, according to one embodiment, the electrostatic repulser 20 has an octagonal shape at its cross-section. It should be noted that the octagonal cross-sectional shape of the electrostatic repulser 20 is only exemplary, and should not be considered as limiting the scope of the present subject matter. The electrostatic repulser 20 can have any shape. According to another embodiment shown in FIG. 13A, the electrostatic repulser 20 comprises six loops 22. Due to the cross-sectional view of FIG. 13A, each loop 22 is represented by two circles. One circle is the induction section 22-902 of the loop 22, and another circle is the return section 22-904 of the loop 22. A detailed description of the loop 22, including the induction section 22-902 and the return section 22-904, is given in the description of FIG. 10. An exemplary number of six loops 22 is shown in FIG. 13A.

According to one embodiment, shown in FIG. 13A, the loops 22 are arranged in the electrostatic repulser 20 in a manner that the induction section 22-902 of one loop 22 is aside the induction section 22-902 of an adjacent loop, and the return section 22-904 of one loop 22 is aside the return section 22-904 of an adjacent loop 22.

Another feature that is shown in FIG. 13A, is a sequential operation of the loops 22, namely a sequential passage of the inducing elements 30 through the loops 22. As mentioned above, each loop 22 comprises therewithin an inducing element 30 that is configured to pass through the loop 22. According to the embodiment shown in FIG. 13A, the inducing elements 30 do not pass through the loops 22 simultaneously, but in sequence in a manner the produces a kind of a pulse of inducing elements 30 passage through the loops 22. Arrow 951 indicates a first pulse of passage of the inducing element 30 in the loop 22 from which arrow 951 originates and then in the loop 22 at which arrow 951 ends. In other words, an inducing element 30 passes in the loop 22 from which arrow 951 originates and then in the loop 22 at which arrow 951 ends. Then, in a counterclockwise direction, an inducing element 30 passes in the loop 22 at which arrow 952 ends, then an inducing element 30 passes in the loop 22 at which arrow 953 ends, and so on. When an inducing element 30 passes in the loop 22 at which arrow 956 ends, a new cycle of pulse of passage of the inducing element 30 starts again. Arrow 950 indicates the direction of this pulse, which is counterclockwise. According to one embodiment, this pulse contributes to the movement of the ioinized gases through the magnetic field area 118.

The electrostatic repulser 20 shown in FIG. 13B is similar in structure and operation to the electrostatic repulser 20 shown in FIG. 13A except that it comprises six pairs of loops 22, namely a total of 12 loops 22.

The above description of the electromagnetic propulsion system 1 also includes a description of a method for repulsing air through the electromagnetic propulsion system, in higher acceleration rates and velocities compared to prior art jet engines.

It is appreciated that certain features of the subject matter, which are, for clarity, described in the context of separate embodiments, may also be provided in combination in a single embodiment. Conversely, various features of the subject matter, which are, for brevity, described in the context of a single embodiment, may also be provided separately or in any suitable sub combination.

Although the subject matter has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

1. An electromagnetic propulsion system comprising:
at least one electromagnetic thrustor configured to intake air, ionize the air to produce ionized air, pass the ionized air through at least one electromagnetic field and emit the ionized air in a first direction, to reach acceleration, thereby creating a thrust force in a second direction that is opposite to the first direction, and
an electrostatic repulser surrounding the at least one electromagnetic field, configured to pass at least one inducing element therethrough and control a velocity and acceleration rate of the at least one inducing element,
wherein a velocity and acceleration rate of the ionized air through the at least one electromagnetic thrustor is induced by the velocity and acceleration rate of the at least one inducing element in the electrostatic repulser.

2. The electromagnetic propulsion system of claim 1, wherein the electromagnetic thrustor comprises a chamber configured to allow passage of air therethrough, an inlet at one side of the chamber and an outlet at an opposite side of the chamber, wherein the inlet is configured to allow intake of air into the chamber, and the outlet is configured to allow emission of the ionized air therethrough.

3. The electromagnetic propulsion system of claim 2, wherein the ionized air is emitted through the outlet in a first direction, and as a result a thrust force in a second direction is generated, when the second direction is opposite to the first direction.

4. The electromagnetic propulsion system of claim 2, wherein the electromagnetic thrustor comprises an inlet turbine installed at the inlet and configured to intake air and push the air into the chamber through the inlet, wherein the inlet turbine comprises an opening configured to let air enter into the inlet turbine, and an exit configured to let the air exit out of the inlet turbine and enter into the chamber through the inlet.

5. The electromagnetic propulsion system of claim 4, wherein the inlet turbine starts to rotate by an electrical motor that is detachably mechanically connected to the inlet turbine, and wherein the motor is energetically connected to a power source configured to provide energy to the motor.

6. The electromagnetic propulsion system of claim 2, wherein the chamber is bent and comprises a bent spot, wherein a part of the chamber that is upstream to the bent spot, including the inlet, is substantially vertical, when the inlet faces upwards; and a part of the chamber that is downstream to the bent spot, including the outlet, is substantially horizontal.

7. The electromagnetic propulsion system of claim 2, further comprising an ionizer configured to ionize the air that flows along the chamber and as a result produce ionized air, wherein the ionizer is positioned downstream to the inlet.

8. The electromagnetic propulsion system of claim 7, wherein the chamber further comprises a magnetic field area configured to comprise the magnetic field therein, downstream the ionizer, thus allowing flow of the ionized air from the ionizer to the magnetic field area, and from the magnetic field area to the outlet and out through the outlet in the first direction.

9. The electromagnetic propulsion system of claim 8, further comprising an alternator that is configured to convert a mechanical energy of the flow of the ionized air out of the magnetic field area to an electrical energy, in a form of electrical current, wherein the electrical current is used for charging a rechargeable power source.

10. The electromagnetic propulsion system of claim 1, further comprising at least one positively charged gas container fluidically connected to an anode located inside the chamber, at an exit of the magnetic field area, and configured to contain a positively charged gas, and at least one negatively charged gas container fluidically connected to a cathode located inside the chamber, at an inlet of the magnetic field area, and configured to contain a negatively charged gas.

11. The electromagnetic propulsion system of claim 8, wherein the electrostatic repulser comprising a plurality of loops that surround the magnetic field area, wherein each loop has a hollow tube-like structure comprising an interior and a wall enclosing the interior, wherein the loop is configured to comprise the inducing element in the interior, wherein the inducing element is configured to pass inside the interior of the loop.

12. The electromagnetic propulsion system of claim 11, wherein the loop comprising an induction section in which the inducing element passes in the first direction, and a return section in which the inducing element passes in the second direction.

13. The electromagnetic propulsion system of claim 12, wherein the induction section of each loop is in proximity to the magnetic field area in a manner that allows induction of the movement of the ionized air through the magnetic field area by the passing of the inducing element through the induction section of the loop, and the return section of each loop is distant from the magnetic field area in a manner that does not allow influence of the passage of the inducing element through the return section of the loop on the movement of the ionized air through the magnetic field area.

14. The electromagnetic propulsion system of claim 13, wherein the inducing element is made of a material that is attracted to a magnetic field.

15. The electromagnetic propulsion system of claim 14, wherein the movement of the inducing element along the induction section is controlled by a sequence of a plurality of magnetic fields that are created along the induction section in the first direction one after the other.
